(19) United States
(12) Patent Application Publication
(10) Pub. No.: US 2023/0083915 A1
(43) Pub. Date: Mar. 16, 2023

(54) Method and Device for Controlling Hybrid Vehicle

(71) Applicants: Hyundai Motor Company, Seoul (KR); Kia Corporation, Seoul (KR)

(72) Inventors: Jae Young Choi, Seoul (KR); Mingyun Jo, Seoul (KR); Hyukjin Lee, Suwon-si (KR); Seoho Lee, Siheung-si (KR)

(21) Appl. No.: 17/457,383

(22) Filed: Dec. 2, 2021

(30) Foreign Application Priority Data
Sep. 15, 2021 (KR) 10-2021-0123314

(51) Int. Cl. B60W 20/40; B60W 10/06; B60W 10/08; B60W 30/188; B60W 30/184

(52) U.S. Cl. CPC B60W 20/40; B60W 10/06; B60W 10/08; B60W 30/1882; B60W 30/184; B60K 2006/268

(57) ABSTRACT

An embodiment method for controlling a hybrid vehicle includes driving a motor that starts an engine of the hybrid vehicle and controlling the motor to generate an engine starting torque to prevent a vibration of the engine, wherein the engine starting torque is generated by a feedforward control method. An embodiment device for controlling a hybrid vehicle includes a motor configured to start an engine of the hybrid vehicle, and a controller configured to drive the motor and control the motor to generate an engine starting torque to prevent a vibration of the engine, wherein the engine starting torque is generated by a feedforward control method.

### CROSS-REFERENCE TO RELATED APPLICATIONS

This application claims the benefit of Korean Patent Application No. 10-2021-0123314, filed on Sep. 15, 2021, which application is hereby incorporated herein by reference.

### TECHNICAL FIELD

The present invention relates to a vehicle.

### BACKGROUND

An eco-friendly vehicle includes a fuel cell vehicle, an electric vehicle, a plug-in electric vehicle, and a hybrid vehicle, and typically includes a motor for generating a driving force.

The hybrid vehicle which is an example of such an eco-friendly vehicle uses an internal combustion engine and battery power supply together. That is, the hybrid vehicle efficiently combines and uses the power of the internal combustion engine and the power of the motor.

The hybrid vehicle may include an engine, a motor, an engine clutch that controls power between the engine and the motor, a transmission, a differential gear device, a battery, a starter-generator that starts the engine or generates power by the output of the engine, and wheels.

In addition, the hybrid vehicle may include a hybrid control unit that controls the overall operation of the hybrid vehicle, an engine control unit that controls the operation of the engine, a motor control unit that controls the operation of the motor, a transmission control unit that controls the operation of the transmission, and a battery control unit that controls and manages the battery.

The battery control unit may be called a battery management system. The starter-generator may be called an integrated starter & generator (ISG) or a hybrid starter & generator (HSG).

The hybrid vehicle as described above may operate in driving modes such as an electric vehicle (EV) mode that is a pure electric vehicle mode in which only the power of the motor is used, a hybrid electric vehicle (HEV) mode in which the rotational power of the motor is used as an auxiliary power while the rotational power of the engine is used as a main power, and a regenerative braking mode in which braking and inertia energy are recovered through power generation of the motor during braking or driving of the vehicle and charged to the battery.

A flywheel is installed between the engine and the transmission in order to prevent a torsional vibration occurring in a crankshaft of the engine. Recently, excluding a single mass flywheel, a dual mass fly wheel (DMF) having a wide damping area in terms of noise, vibration, and harshness (NVH) attenuation has been mounted.

The DMF is divided into a first flywheel and a second flywheel, the first flywheel is fixed to a crankshaft, and the second flywheel is connected to the transmission side via a clutch. Accordingly, when the rotational force of the crankshaft is transmitted to the first flywheel, the damping means is tension-compressed by a relative rotational speed difference between the first flywheel and the second flywheel, and thus the torsional vibration, etc. may be attenuated.

The above information disclosed in this Background section is only for enhancement of understanding of the background of the invention, and therefore it may contain information that does not form the prior art that is already known to a person of ordinary skill in the art.

### SUMMARY

The present invention relates to a vehicle. Particular embodiments relate to a method and device for controlling a hybrid vehicle.

Embodiments of the present invention provide a method and device for controlling a hybrid vehicle having advantages of performing a function of a flywheel (e.g., dual mass flywheel (DMF)) connected to an engine using a motor (e.g., a starter-generator) connected to the engine.

An exemplary embodiment of the present invention provides a method for controlling a hybrid vehicle including driving, by a controller, a motor that starts an engine of the hybrid vehicle, and controlling, by the controller, the motor to generate an engine starting torque for preventing a vibration of the engine, wherein the engine starting torque is generated by a feedforward control method.

The engine starting torque may be a value corresponding to an intake temperature of the engine and a temperature of the engine.

The engine starting torque may be a value corresponding to an outside temperature of the engine and a temperature of the engine.

The method may further include determining, by the controller, whether the vibration of the engine occurs after the engine starting torque is generated, and generating, by the controller, an anti-vibration torque for preventing the vibration of the engine using the motor when the vibration of the engine occurs after the engine starting torque is generated, wherein the anti-vibration torque may be generated by a feedback control method.

Another embodiment of the present invention provides a device for controlling a hybrid vehicle including a motor configured to start an engine of the hybrid vehicle, and a controller configured to drive the motor, wherein the controller may control the motor to generate an engine starting torque for preventing a vibration of the engine, and wherein the engine starting torque may be generated by a feedforward control method.

The engine starting torque may be a value corresponding to an intake temperature of the engine and a temperature of the engine.

The engine starting torque may be a value corresponding to an outside temperature of the engine and a temperature of the engine.

The controller may determine whether the vibration of the engine occurs after the engine starting torque is generated, the controller may generate an anti-vibration torque for preventing the vibration of the engine using the motor when the vibration of the engine occurs after the engine starting torque is generated, and the anti-vibration torque may be generated by a feedback control method.

The method and device for controlling a hybrid vehicle according to an exemplary embodiment of the present invention described above may perform a function of a flywheel (e.g., dual mass flywheel (DMF)) connected to an engine using a motor (e.g., a starter-generator) connected to the engine.

In addition, an exemplary embodiment of the present invention does not include a flywheel that is an inertia body, thereby reducing the weight of the hybrid vehicle, improving the fuel efficiency of the vehicle, and reducing the cost of the vehicle.

### BRIEF DESCRIPTION OF THE DRAWINGS

In order to more fully understand the drawings used in the detailed description of the present invention, a brief description of each drawing is provided.

FIG. 1 is a flowchart illustrating a method for controlling a hybrid vehicle according to an exemplary embodiment of the present invention.

FIG. 2 is a diagram illustrating a device for controlling the hybrid vehicle to which the method for controlling the hybrid vehicle illustrated in FIG. 1 is applied.

The following descriptions may be used in connection with the drawings to further explain embodiments of the present invention.
200: controller
210: engine
220: starter-generator

### DETAILED DESCRIPTION OF ILLUSTRATIVE EMBODIMENTS

In order to fully understand the present invention and the objects achieved by the embodying of the present invention, reference should be made to the accompanying drawings illustrating exemplary embodiments of the present invention and the description indicated in the accompanying drawings.

Hereinafter, the present invention will be described in detail by describing exemplary embodiments of the present invention with reference to the accompanying drawings. In describing embodiments of the present invention, when it is determined that a detailed description of a related known configuration or function may obscure the gist of the present invention, the detailed description will be omitted. The same reference numerals presented in each drawing may indicate the same constituent element.

The terminology used in the specification is used only to describe a specific exemplary embodiment, and is not intended to limit the present invention. Expressions in the singular include a plurality of expressions unless the context clearly dictates otherwise. In the specification, the terms such as “comprise” or “have” are intended to designate the presence of a feature, number, step, operation, constituent element, part, or combinations thereof described in the specification, and it should be understood that the terms do not preclude in advance the possibility of the presence or addition of one or more other features, numbers, steps, operations, constituent elements, parts or combinations thereof.

Throughout this specification and the claims that follow, when it is described that an element is “coupled” to another element, not only may it be “directly coupled” to the other element, but also it may be “electrically or mechanically coupled” to the other element with another constituent element therebetween.

Unless defined otherwise, terms used herein, including technical or scientific terms, have the same meaning as commonly understood by a person of ordinary skill in the art to which the present invention belongs. Terms such as those defined in a generally used dictionary should be interpreted as having a meaning consistent with the meaning in the context of the related technology, and unless explicitly defined in the specification, are not interpreted in an ideal or excessively formal meaning.

A dual mass flywheel (DMF) is directly connected to an engine of a vehicle. The DMF may reduce the fluctuation of the engine generated when the engine is started so that the vehicle may enable a stable operation. According to the related art, since the DMF is additionally connected to the engine, the weight of the vehicle may increase and the fuel efficiency of the vehicle may decrease.

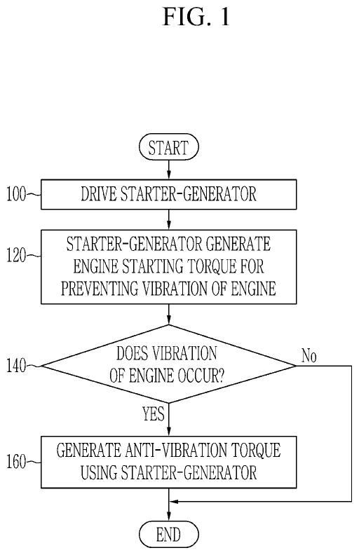

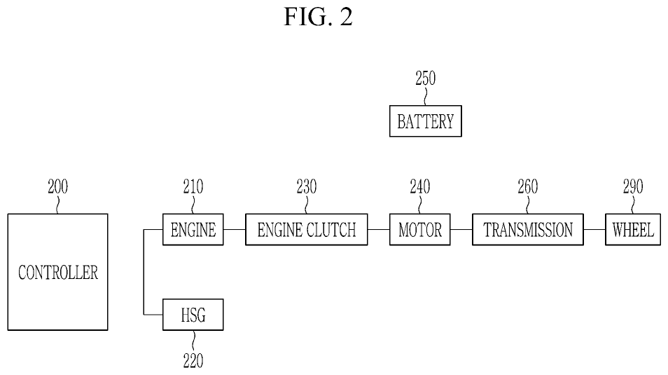

FIG. 1 is a flowchart illustrating a method for controlling a hybrid vehicle according to an exemplary embodiment of the present invention. FIG. 2 is a block diagram illustrating a device for controlling the hybrid vehicle to which the method for controlling the hybrid vehicle illustrated in FIG. 1 is applied.

Referring to FIGS. 1 and 2, in a driving step 100, a controller 200 may drive a first motor (e.g., a starter-generator) (HSG) 220 that starts an engine 210 of the hybrid vehicle. For example, the controller 200 may drive the starter-generator 220 in response to a request signal of a driver of the vehicle.

The controller 200 is an electronic control unit (ECU) and may control the entire operation of the hybrid vehicle. The controller 200 may be, for example, at least one microprocessor operating by a program (control logic) or hardware (e.g., a microcomputer) including the microprocessor. The program may include a series of instructions for performing the method for controlling the hybrid vehicle according to an exemplary embodiment of the present invention. The instructions may be stored in a memory of the device for controlling the hybrid vehicle or the controller 200.

The hybrid vehicle includes the controller 200, the engine 210, the first motor (e.g., a hybrid starter & generator (HSG)) 220 that is an electric motor, an engine clutch 230, a second motor (or a driving motor) 240 which may be an electric motor, a battery 250, a transmission 260, and driving wheels 290 which are wheels. The device for controlling the hybrid vehicle may include the controller 200 and the starter-generator 220.

The hybrid vehicle, which is a hybrid electric vehicle, may use the engine 210 and the motor 240 as a power source, and may include the engine clutch 230 between the motor 240 and the engine 210 to operate in an electric vehicle (EV) mode in which the hybrid vehicle is driven by the motor 240 when the engine clutch 230 is open, and in a hybrid electric vehicle (HEV) mode in which the hybrid vehicle is driven by both the motor 240 and the engine 210 when the engine clutch 230 is closed.

The hybrid vehicle may include a transmission mounted electric device (TMED) type power train to which the motor 240 and the transmission 260 are attached, and include the engine clutch 230 between power sources including the motor 240 and the engine 210 to provide an operation (driving) of the EV mode (electric vehicle mode) which is a pure electric vehicle mode in which only the power of the motor 240 is used depending on whether the engine clutch 230 is engaged (coupled) or the hybrid electric vehicle mode (HEV) in which the rotational power of the motor 240 is used as an auxiliary power while the rotational power of the engine 210 is used as a main power. In more detail, in the hybrid vehicle having a structure in which the motor 240 is directly connected to the transmission 260, engine revolutions per minute (RPM) is elevated through the driving of the HSG 220, power transmission and blocking of the engine 210 are performed through engagement (coupling) and separation of the clutch 230, driving force is generated in the wheels 290 through a power transmission system that may include the transmission 260, and when a torque transmission of the engine 210 is requested, the engine torque may be transmitted through the engagement of the clutch 230.

The controller 200 may include a hybrid control unit (HCU), a motor control unit (MCU), an engine control unit (ECU), and a transmission control unit (TCU).

The HCU may control driving (starting) of the engine 210 through the control of the HSG 220 when the engine 210 is stopped. The HCU, which is as a top-level controller, may integrally control controllers such as an MCU connected over a network such as a controller area network (CAN) which is a vehicle network, and may control the overall operation of the hybrid vehicle.

The MCU may control the HSG 220 and the motor 240.

The MCU may control output torque of the driving motor 240 according to a control signal output from the HCU through the above network so that the driving motor 240 may be driven to an area having the maximum efficiency. The MCU may include an inverter including a plurality of power switching devices, and the power switching devices constituting the inverter may include one of an insulated gate bipolar transistor (IGBT), a MOSFET, a FET, a transistor TR, and a relay. The inverter may drive the driving motor 240 by converting direct current (DC) voltage supplied from the battery 250 into a three-phase alternating current (AC) voltage. The MCU may be disposed between the battery 250 and the motor 240.

The ECU may control torque of the engine 210. The ECU may control an operating point of the engine 210 according to a control signal output from the HCU through the above network so that the engine 210 may output the optimal torque. The TCU may control the operation of the transmission 260.

The engine 210 may include any one of a diesel engine, a gasoline engine, an LPG engine, and an LNG engine, and output the torque to an operating point according to a control signal output from the ECU to appropriately maintain a driving force combination with the driving motor 240 in the HEV mode.

The engine 210 may generate power coupled to the motor 240 through the engine clutch 230 and transmitted to the transmission 260.

The HSG 220 may operate as an electric motor or a generator, operate as an electric motor according to a control signal output from the MCU to execute starting-on of the engine 210, operate as a generator to generate a voltage in a state in which the engine 210 maintains the starting-on, and provide the generated voltage to the battery 250 as a charging voltage through the inverter. The HSG 220 may be connected to the engine 210 by a belt. The HSG 220 is a motor for cranking the engine 210 and may be connected to the engine 210 directly or by the belt. In another exemplary embodiment of the present invention, the HSG 220 may be disposed between the engine 210 and the engine clutch 230.

The engine clutch 230 may be disposed (mounted) between the engine 210 and the driving motor 240 to intermit power transmission (power connection) so that the operation of the EV mode and the HEV mode may be provided. The operation of the engine clutch 230 may be controlled by the controller 200.

The driving motor 240 may operate by the three-phase AC voltage output from the MCU to generate torque, and operate as a generator in a coasting drive or regenerative braking to supply regenerative energy to the battery 250.

The battery 250 includes a plurality of unit cells, and may store a high voltage of, for example, DC 260 V to 450 V, for providing a voltage to the driving motor 240 or the HSG 220 providing the driving force to the wheels 290.

The transmission 260 may be implemented as a multiple speed transmission or multistage transmission such as an automatic transmission or a dual clutch transmission (DCT), and may engage (select) an arbitrary transmission stage when an engagement element and a disengagement element operate by an operation of hydraulic pressure according to the control of the TCU. The transmission 260 may transmit or block the driving force of the engine 210 and/or the motor 240 to the wheels 290.

According to step 120, the controller 200 may control the starter-generator (HSG) 220 to generate engine starting torque (e.g., torque equal to or less than 80 (N·m) or equal to or less than 130 (N·m)) for preventing vibration of the engine 210. The engine starting torque for preventing the vibration of the engine 210 may be stored in the memory of the control device or the controller 200 of the hybrid vehicle, and may be determined as feedforward torque by a test (or an experiment). The engine starting torque may be generated by a feedforward control method.

For example, the engine starting torque for preventing the vibration of the engine 210 may be a value corresponding to an intake temperature of the engine 210 (or an outside temperature of the engine 210) and the temperature of the engine 210. A map table including the engine starting torque according to the intake temperature and the temperature of the engine 210 may be stored in the memory.

According to step 140, after step 120, the controller 200 may determine whether the vibration of the engine 210 (e.g., an instantaneous vibration of the engine 210) occurs using a sensor.

When the vibration of the engine 210 occurs, the method for controlling the hybrid vehicle, which is a process, may proceed to step 160.

According to step 160, the controller 200 may generate anti-vibration torque for preventing the vibration of the engine 210 occurring in step 140 using the starter-generator 220. The anti-vibration torque may be generated by a feedback control (e.g., anti-phase control) method. The anti-vibration torque that is a target value of the feedback control may be determined by a test (or an experiment).

A constituent element or “˜unit” or “˜or” or a block or a module used in an exemplary embodiment of the present invention may be implemented as software such as a task, a class, a subroutine, a process, an object, a thread of execution, and a program executed in a certain area on a memory or hardware such as a field-programmable gate array (FPGA) or an application-specific integrated circuit (ASIC), and may be in a combination of the software and the hardware. The constituent element or ‘˜unit’ may be included in a computer-readable storage medium, or a part thereof may be dispersed and distributed in a plurality of computers.

As described above, an exemplary embodiment has been disclosed in the drawings and specification. Here, specific terms are used but are merely used to describe the present invention and are not used to limit the meaning or the scope of the present invention described in the claims. Therefore, a person of an ordinary skill will understand that various modifications and equivalent exemplary embodiments are possible from the present invention. Therefore, the true technical protection scope of the present invention should be determined by the technical spirit of the appended claims.

What is claimed is:

1. A method for controlling a hybrid vehicle, the method comprising:
driving a motor that starts an engine of the hybrid vehicle; and
controlling the motor to generate an engine starting torque to prevent a vibration of the engine,
wherein the engine starting torque is generated by a feedforward control method.

2. The method of claim 1, wherein the engine starting torque is a value corresponding to an intake temperature of the engine and a temperature of the engine.

3. The method of claim 1, wherein the engine starting torque is a value corresponding to an outside temperature of the engine and a temperature of the engine.

4. The method of claim 1, further comprising:
determining whether the vibration of the engine occurs after the engine starting torque is generated; and
generating an anti-vibration torque to prevent the vibration of the engine using the motor upon determining that the vibration of the engine occurs after the engine starting torque is generated,
wherein the anti-vibration torque is generated by a feedback control method.

5. The method of claim 1, wherein the engine starting torque is torque equal to or less than 80 (N·m).

6. The method of claim 1, wherein the engine starting torque is torque equal to or less than 130 (N·m).

7. The method of claim 1, wherein the motor is a hybrid starter and generator.

8. A device for controlling a hybrid vehicle, the device comprising:
a motor configured to start an engine of the hybrid vehicle; and
a controller configured to:
drive the motor; and
control the motor to generate an engine starting torque to prevent a vibration of the engine,
wherein the engine starting torque is generated by a feedforward control method.

9. The device of claim 8, wherein the engine starting torque is a value corresponding to an intake temperature of the engine and a temperature of the engine.

10. The device of claim 8, wherein the engine starting torque is a value corresponding to an outside temperature of the engine and a temperature of the engine.

11. The device of claim 8, wherein the controller is further configured to:
determine whether the vibration of the engine occurs after the engine starting torque is generated; and
generate an anti-vibration torque to prevent the vibration of the engine using the motor in response to a determination that the vibration of the engine occurs after the engine starting torque is generated, wherein the anti-vibration torque is generated by a feedback control method.

12. The device of claim 8, wherein the controller includes an electronic control unit, a hybrid control unit, a motor control unit, an engine control unit, and a transmission control unit.

13. The device of claim 8, wherein the engine starting torque is torque equal to or less than 80 (N·m).

14. The device of claim 8, wherein the engine starting torque is torque equal to or less than 130 (N·m).

15. The device of claim 8, wherein the motor is a hybrid starter and generator.

16. A hybrid vehicle comprising:
an engine;
a motor;
an engine clutch configured to control power between the engine and the motor;
a transmission;
a differential gear device;
a battery;
a starter-generator configured to start the engine or generate power by an output of the engine; and
a controller configured to control the starter-generator to generate an engine starting torque to prevent a vibration of the engine, wherein the engine starting torque is generated by a feedforward control method.

17. The hybrid vehicle of claim 16, wherein the engine starting torque is a value corresponding to an intake temperature of the engine and a temperature of the engine.

18. The hybrid vehicle of claim 16, wherein the engine starting torque is a value corresponding to an outside temperature of the engine and a temperature of the engine.

19. The hybrid vehicle of claim 16, wherein the controller is further configured to:
determine whether the vibration of the engine occurs after the engine starting torque is generated; and
generate an anti-vibration torque to prevent the vibration of the engine using the starter-generator in response to a determination that the vibration of the engine occurs after the engine starting torque is generated, wherein the anti-vibration torque is generated by a feedback control method.

20. The hybrid vehicle of claim 16, wherein the engine starting torque is torque equal to or less than 80 (N·m).
